(19) United States
(12) Patent Application Publication
(10) Pub. No.: US 2020/0153368 A1
(43) Pub. Date: May 14, 2020

(54) ELECTRIC OIL PUMP

(71) Applicant: NIDEC TOSOK CORPORATION, Kanagawa (JP)

(72) Inventors: Yoshiyuki KOBAYASHI, Kanagawa (JP); Kazuhiro HOMMA, Kanagawa (JP); Koji HIGUCHI, Kanagawa (JP); Yutaka HASHIMOTO, Kanagawa (JP)

(73) Assignee: NIDEC TOSOK CORPORATION, Kanagawa (JP)

(21) Appl. No.: 16/676,406

(22) Filed: Nov. 6, 2019

(30) Foreign Application Priority Data
Nov. 9, 2018 (JP) 2018-211234

(51) Int. Cl. H02P 6/16; F04D 13/06; H02K 7/00; F01M 11/00; H02K 5/22

(52) U.S. Cl. CPC H02P 6/16; F04D 13/06; F01M 2011/035; F01M 11/00; H02K 5/225; H02K 7/003

(57) ABSTRACT

Provided is an electric oil pump that does not degrade assembly operability and does not require a complicated configuration. The electric oil pump includes a motor portion that has a motor shaft disposed along a center axis extending in an axial direction; a pump portion that is disposed on one side of the motor portion in the axial direction, is driven by the motor portion via the motor shaft, and suctions and ejects an oil, and an inverter portion that is disposed on one side of the pump portion in the axial direction and drives the motor portion, the motor shaft penetrates through the pump portion, and the electric oil pump further includes a rotation angle sensor that is disposed at the inverter portion and detects a rotation angle of the motor shaft.

### CROSS-REFERENCE TO RELATED APPLICATION

This application claims the priority of Japan patent application serial no. 2018-211234, filed on Nov. 9, 2018. The entirety of the above-mentioned patent application is hereby incorporated by reference herein and made a part of this specification.

### BACKGROUND

### Technical Field

The present disclosure relates to an electric oil pump.

### Description of Related Art

A structure of an electric oil pump including a pump portion, a motor portion that drives the pump portion, and an inverter portion that drives the motor portion is known. In the electric oil pump, the pump portion is disposed on one side of the motor portion in an axial direction, for example, and a rotation angle of a motor shaft of the motor portion is detected on the other side of the motor portion in the axial direction.

For example, FIG. 2 in Patent Document 1 illustrates an electric oil pump in which a pump portion is disposed on one side of a motor portion in an axial direction and a rotation angle sensor that detects a rotation angle of a motor shaft of the motor portion is disposed on the other side of the motor portion in the axial direction.

Incidentally, disposition of an inverter portion on one side of the pump portion in an axial line, for example, is conceivable when the respective components of the electric oil pump are disposed. In this case, according to the configuration disclosed in Patent Document 1, a wiring for connecting the rotation angle sensor disposed on the other side of the motor portion in the axial direction to the inverter portion is required, and in a case in which the wiring is used, there are problems such as degradation of assembly operability and complication of the configuration including a need to provide a structure for securing the wiring in the surroundings of the electric oil pump.

### PATENT DOCUMENTS

[Patent Document 1] Japanese Patent Application Laid-Open No. 2014-183599

### SUMMARY

The disclosure provides an electric oil pump that does not degrade assembly operability and does not require a complicated configuration in a configuration in which a pump portion is disposed on one side of a motor portion in an axial direction and an inverter portion is disposed on one side of the pump portion in the axial direction.

According to a first exemplary embodiment of the application, an electric oil pump includes: a motor portion that has a motor shaft extending in an axial direction and disposed along a center axis; a pump portion that is disposed on one side of the motor portion in the axial direction, is driven by the motor portion via the motor shaft, and suctions and ejects an oil, and an inverter portion that is disposed on one side of the pump portion in the axial direction and drives the motor portion, the motor shaft penetrates through the pump portion, and the electric oil pump further includes a rotation angle sensor that is disposed at the inverter portion and detects a rotation angle of the motor shaft.

According to the first exemplary embodiment of the disclosure, it is possible to provide an electric oil pump that does not degrade assembly operability and does not require a complicated configuration in a configuration in which a pump portion is disposed on one side of a motor portion in an axial direction and an inverter portion is disposed on one side of the pump portion in the axial direction.

### BRIEF DESCRIPTION OF THE DRAWINGS

FIG. 1 is an outline side sectional view of an electric oil pump according to a first embodiment of the disclosure.

FIG. 2 is an enlarged sectional view illustrating an inverter portion 70 according to the first embodiment of the disclosure.

FIG. 3 is an enlarged sectional view illustrating an inverter portion 170 according to the first embodiment of the disclosure.

FIG. 4 is an enlarged sectional view illustrating an inverter portion 270 according to the first embodiment of the disclosure.

### DESCRIPTION OF THE EMBODIMENTS

Hereinafter, an electric oil pump according to an embodiment of the disclosure will be described with reference to drawings. Although an electric oil pump that supplies an oil to a transmission that is mounted in a vehicle such as a car will be described in the embodiment, the disclosure is not limited thereto and can also be applied to an electric oil pump for any purpose. In addition, scales, numbers, and the like of the respective structures may be illustrated differently from those of actual structures in the following drawings so that the configurations can be easily understood.

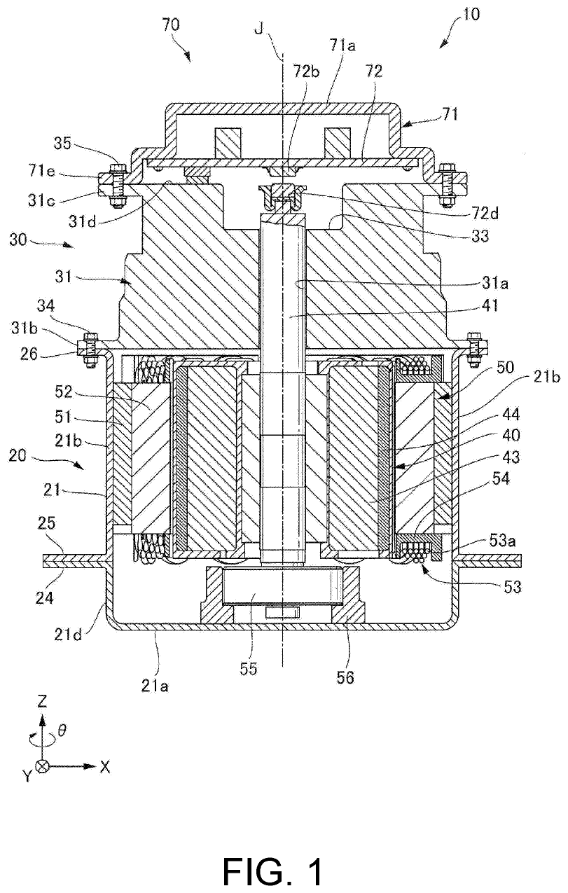

Also, an XYZ coordinate system will appropriately be illustrated as a three-dimensional orthogonal coordinate system in the drawings. In the XYZ coordinate system, a Z-axis direction is defined as a direction that is parallel to a center axis J illustrated in FIG. 1 (a vertical direction in FIG. 1). An X-axis direction is defined as a direction that is parallel to a short direction of the electric oil pump illustrated in FIG. 1 (left and right directions in FIG. 1). A Y-axis direction is defined as a direction that perpendicularly intersects both the X-axis direction and the Z-axis direction.

In addition, a positive side (+Z side) in the Z-axis direction will be referred to as a “front side” or “one side,” and a negative side (−Z side) in the Z-axis direction will be referred to as a “rear side” or “the other side” in the following description. Also, the rear side (the other side) and the front side (the one side) are simply names used for explanation and are not intended to limit actual positional relationships and directions. In addition, a direction that is parallel to the center axis J (Z-axis direction) will simply be referred to as an “axial direction,” a radial direction around the center axis J will simply be referred to as a “radial direction,” and a circumferential direction around the center axis J, that is, surrounding the center axis (0 direction) will simply be referred to as a “circumferential direction” unless otherwise particularly stated.

In addition, “extend in the axial direction” in the specification includes a case in which a configuration extends in a direction inclined within a range of less than 45° relative to the axial direction in addition to a case in which the configuration extends strictly in the axial direction (Z-axis direction). Also, “extend in the radial direction” in the specification includes a case in which a configuration extends in a direction inclined within a range of less than 45° relative to the radial direction in addition to a case in which the configuration extends strictly in the radial direction, that is, in a direction that is perpendicular to the axial direction (Z-axis direction).

### First Embodiment

### <Overall Configuration>

FIG. 1 is an outline side sectional view of an electric oil pump according to a first embodiment of the disclosure.

An electric oil pump 10 according to the embodiment has a motor portion 20, a pump portion 30, and an inverter portion 70. The motor portion 20, the pump portion 30, and the inverter portion 70 are provided in an aligned manner in the axial direction.

The motor portion 20 has a motor shaft 41 that is disposed along the center axis J extending in the axial direction and is rotatably supported around the center axis J, causes the motor shaft 41 to rotate, and drives the pump portion 30. The pump portion 30 is located on the front side (+Z side) of the motor portion 20, is driven by the motor portion 20 via the motor shaft 41, and ejects an oil. The inverter portion 70 is located on the front side (+Z side) of the pump portion 30 and controls driving of the motor portion 20.

Hereinafter, each component will be described in detail.

<Motor Portion 20>

The motor portion 20 has a motor housing 21, a rotor 40, a motor shaft 41, a stator 50, and a bearing 55 as illustrated in FIG. 1.

The motor portion 20 is, for example, an inner rotor-type motor, the rotor 40 is secured to an outer circumferential surface of the motor shaft 41, and the stator 50 is located outward in the radial direction of the rotor 40. In addition, the bearing 55 is disposed at an end of the motor shaft 41 on the rear side (−Z side) and rotatably supports the motor shaft 41.

(Motor Housing 21)

The motor housing 21 has a thin cylindrical shape with a bottom as illustrated in FIG. 1 and has a bottom surface portion 21a, a stator holding portion 21b, a side wall portion 21d, flange portions 24 and 25, and a flange portion 26. The bottom surface portion 21a forms the bottom part, and the stator holding portion 21b and the side wall portion 21d form cylindrical side wall surfaces around the center axis J. An outer surface of the stator 50, that is, an outer surface of a core back portion 51, which will be described later, is fitted to an inner surface of the stator holding portion 21b. In this manner, the stator 50 is accommodated in the motor housing 21. The flange portion 24 spreads outward in the radial direction from an end of the side wall portion 21d on the front side (+Z side). Meanwhile, the flange portion 25 spreads outward in the radial direction from an end of the stator holding portion 21b on the rear side (−Z side). The flange portion 24 and the flange portion 25 face each other and are fastened with a fastening member, which is not illustrated in the drawing. In this manner, the motor portion 20 and the pump portion 30 are secured to the inside of the motor housing 21 in a sealed manner. The flange portion 26 spreads outward in the radial direction from an end of the stator holding portion 21b on the front side (+Z side).

As a material of the motor housing 21, a zinc-aluminum-magnesium-based alloy or the like can be used, for example, and specifically, a steel plate and a steel strip plated with a molten zinc-aluminum-magnesium alloy can be used. Also, a bearing holding portion 56 for holding the bearing 55 is provided at the bottom surface portion 21a.

(Rotor 40)

The rotor 40 has a rotor core 43 and a rotor magnet 44. The rotor core 43 surrounds the motor shaft 41 around the axis (0 direction) and is secured to the motor shaft 41. The rotor magnet 44 is secured to an outer surface of the rotor core 43 along the surroundings of the axis (0 direction). The rotor core 43 and the rotor magnet 44 rotate along with the motor shaft 41.

(Stator 50)

The stator 50 surrounds the rotor 40 around the axis (0 direction) and causes the rotor 40 to rotate around the center axis J. The stator 50 has a core back portion 51, tooth portions 52, a coil 53, and a bobbin (insulator) 54.

The shape of the core back portion 51 is a cylindrical shape that is coaxial with the motor shaft 41. The tooth portions 52 extend from an inner surface of the core back portion 51 toward the motor shaft 41. The number of tooth portions 52 is a plural number, and the tooth portions 52 are disposed at equal intervals in the circumferential direction of the inner surface of the core back portion 51. The coil 53 is provided in the surroundings of the bobbin (insulator) 54 and is configured by a conductive line 53a wound therearound. The bobbin (insulator) 54 is attached to each of the tooth portions 52.

(Bearing 55)

The bearing 55 is disposed on the rear side (−Z side) of the rotor 40 and the stator 50 and is held by the bearing holding portion 56. The bearing 55 supports the motor shaft 41. The shape, the structure, and the like of the bearing 55 are not particularly limited, and any known bearing can be used.

(Rotation Angle Sensor Magnet 72d)

The motor portion 20 has a rotation angle sensor magnet 72d. The rotation angle sensor magnet 72d is disposed at an end of the motor shaft 41 on the front side (+Z side). The rotation angle sensor magnet 72d is secured to the end of the motor shaft 41 on the front side (+Z side) and rotates with rotation of the motor shaft 41. It is possible to detect a rotation angle of the motor shaft 41 by detecting a rotation angle of the rotation angle sensor magnet 72d.

<Pump Portion 30>

The pump portion 30 is provided on one side of the motor portion 20 in the axial direction, in more detail, on the front side (+Z side). The pump portion 30 has the same rotation axis as the motor portion 20 and is driven by the motor portion 20 via the motor shaft 41. The pump portion 30 has a positive-displacement pump that feeds an oil with a pressure by a volume in a tightly closed space (oil chamber) being enlarged and reduced. As the positive-displacement pump, a trochoid pump is used, for example. The pump portion 30 may be a pump other than the trochoid pump, and for example, the pump portion 30 may be a vane pump. The pump portion 30 has a pump body 31 and a pump rotor (not illustrated). The pump rotor rotates along with the motor shaft 41.

(Pump Body 31)

The pump body 31 is located on the front side (+Z side) of the motor portion 20. The pump body 31 has a through-hole 31a that penetrates through the inside of the pump body 31 in the axial direction of the center axis J. The motor shaft 41 penetrates through the pump portion 30. The through-hole 31a opens toward the motor portion 20 on the rear side (−Z side) and closes toward the inverter portion 70 on the front side (+Z side). The through-hole 31a serves as a bearing member (sliding bearing), into which the motor shaft 41 is inserted, which rotatably supports the motor shaft 41. The pump body 31 has a recessed portion 33 that is recessed on the rear side (−Z side) in an end surface 31d that is an end surface on the front side (+Z side).

The pump body 31 has a flange portion 31b. The flange portion 31b spreads outward in the radial direction from an end of the pump body 31 on the rear side (−Z side). The pump body 31 is disposed on the front side (+Z side) of the motor portion 20. A surface of the flange portion 31b of the pump body 31 on the rear side (−Z side) comes into contact with a surface of the flange portion 26 of the motor housing 21 on the front side (+Z side). The pump body 31 is secured to the motor housing 21 by fastening the flange portion 31b and the flange portion 26 with a fastening member 34 such as a bolt or a nut.

The pump body 31 has a flange portion 31c. The flange portion 31c spreads outward in the radial direction from an end of the pump body 31 on the front side (+Z side). As a material of the pump body 31, it is possible to use cast iron, for example.

<Inverter Portion 70>

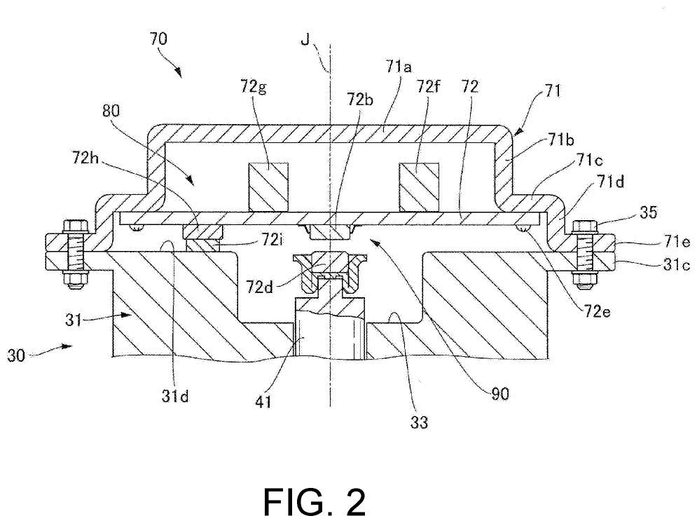

FIG. 2 is an enlarged sectional view illustrating the inverter portion 70 according to the embodiment.

The inverter portion 70 is provided on the front side (+Z side) of the pump portion 30 and controls driving of the motor portion 20. The inverter portion 70 has an inverter housing 71 and a substrate 72.

(Inverter Housing 71)

The inverter housing 71 has a cylindrical shape with a bottom and has a bottom surface portion 71a, a side wall portion 71b, a substrate support portion 71c, a side wall portion 71d, and a flange portion 71e.

The bottom surface portion 71a spreads in a direction parallel to the surface that perpendicularly intersects the center axis J. The side wall portion 71b extends on the rear side (−Z side) from an end of the bottom surface portion 71a located outward in the radial direction. The substrate support portion 71c extends outward in the radial direction from an end of the side wall portion 71b on the rear side (−Z side). The side wall portion 71d extends on the rear side (−Z side) from an end of the substrate support portion 71c located outward in the radial direction. The flange portion 71e extends outward in the radial direction from an end of the side wall portion 71d on the rear side (−Z side).

The inverter housing 71 is disposed on the front side (+Z side) of the pump body 31. A surface of the flange portion 71e of the inverter housing 71 on the rear side (−Z side) comes into contact with a surface of the flange portion 31c of the pump body 31 on the front side (+Z side). The inverter housing 71 is secured to the pump body 31 by fastening the flange portion 71e and the flange portion 31c with a fastening member 35 such as a bolt or a nut.

A surface of the substrate support portion 71c on the rear side (−Z side) comes into contact with a surface of the substrate 72 on the front side (+Z side). The substrate 72 is secured to the inverter housing 71 by fastening the substrate 72 and the substrate support portion 71c with a fastening member 72e such as a screw. Also, the substrate 72 may have a structure adapted to be secured to the pump body 31.

(Substrate 72)

A rotation angle detection sensor 72b that configures a rotation angle detection circuit 90 is mounted on the substrate 72. Electronic components 72f, 72g, and 72h that configure the inverter circuit 80 for driving the motor portion 20 are mounted on the substrate 72. The electronic components 72f, 72g, and 72h include heat generating elements such as a switching element (for example, a field effect transistor (FET), an insulated gate bipolar transistor (IGBT)) and a capacitor.

The rotation angle detection sensor 72b and the electronic component 72h are mounted on a surface of the substrate 72 on the rear side (−Z side). The electronic components 72f and 72g are mounted on a surface of the substrate 72 on the front side (+Z side). The rotation angle detection sensor 72b and the electronic component 72h are disposed between the substrate 72 and the pump body 31. The electronic components 72f and 72g are disposed between the substrate 72 and the bottom surface portion 71a. A structure in which the electronic components 72f and 72g are disposed between the substrate 72 and the pump body 31 may also be employed. A configuration in which the electronic component 72h is disposed between the substrate 72 and the bottom surface portion 71a may also be employed.

The rotation angle detection sensor 72b is disposed at a position at which the rotation angle detection sensor 72b faces the rotation angle sensor magnet 72d. If the motor shaft 41 rotates, then the rotation angle sensor magnet 72d also rotates, and a magnetic flux is thus changed. The rotation angle detection sensor 72b is an MR sensor, for example, detects the change in magnetic flux due to the rotation of the rotation angle sensor magnet 72d, and thus detects a rotation angle of the motor shaft 41. In addition, the rotation angle detection sensor 72b that detects the rotation angle of the motor shaft 41 is not limited to one that detects a change in magnetic flux due to rotation of the magnet as in the embodiment, and an encoder or the like may be used.

A heat discharge member 72i is disposed between a surface of the electronic component 72h on the rear side (−Z side) and an end surface 31d of the pump body 31 on the front side (+Z side). The heat discharge member 72i is a high heat transmission member, and a heat discharge gel is used, for example. In a case in which the electronic component 72f is a component that generates heat on the side of the substrate 72, for example, the heat discharge member may be disposed between a surface of the substrate 72 on the rear side (−Z side) of the position at which the electronic component 72f is mounted and the end surface 31d of the pump body 31 on the front side (+Z side). The heat generated by the electronic component 72h is likely to move to the pump body 31, and it is possible to improve heat discharge efficiency of the substrate 72 by providing the heat discharge member 72i.

(Inverter Circuit 80)

The inverter circuit 80 is configured by mounting the electronic components 72f, 72g, and 72h and various electronic components (not illustrated) on the substrate 72. The inverter circuit 80 includes a heat generating element. The inverter circuit 80 supplies electric power to the motor portion 20 and controls driving, rotation, stop, and the like of the motor portion 20. The control can be performed on the basis of the rotation angle of the motor shaft 41 detected by the rotation angle detection circuit 90.

(Rotation Angle Detection Circuit 90)

The rotation angle detection circuit 90 is configured by mounting the rotation angle detection sensor 72b and various electronic components (not illustrated) on the substrate 72. The rotation angle detection circuit 90 may include a heat generating element in some cases. The rotation angle detection circuit 90 detects a rotation angle of the motor shaft 41. The result of detection performed by the rotation angle detection circuit 90 can be delivered to the inverter circuit 80 via a print wiring on the substrate 72.

### Second Embodiment

### <Inverter Portion 170>

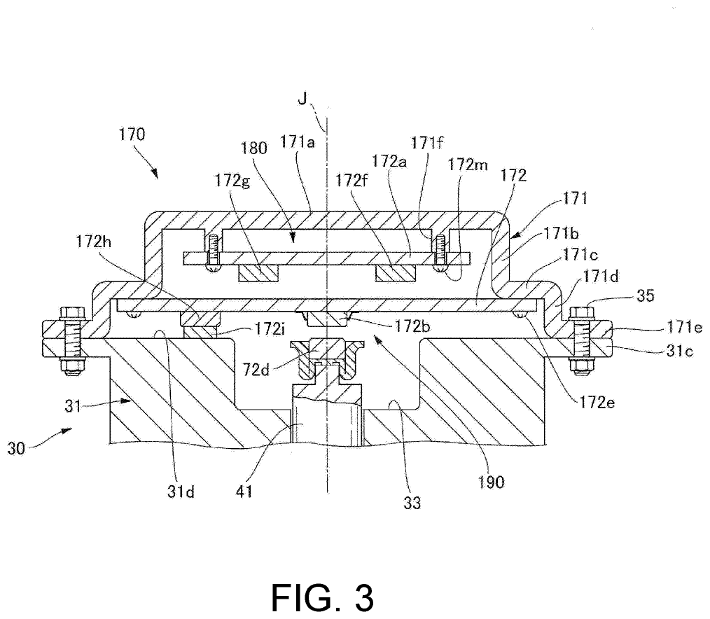

FIG. 3 is an enlarged sectional view illustrating an inverter portion 170 according to a second embodiment. In the second embodiment, the inverter portion 170 is included instead of the inverter portion 70 in the first embodiment. Since the configurations of the motor portion 20 and the pump portion 30 in the second embodiment are the same as those in the first embodiment illustrated in FIG. 1, illustration and detailed description thereof will be omitted.

The inverter portion 170 is provided on the front side (+Z side) of the pump portion 30 and controls driving of the motor portion 20. The inverter portion 170 has an inverter housing 171, a substrate 172, and a substrate 172a. The substrate 172 and the substrate 172a are stacked in the axial direction. The substrate 172 is disposed on the rear side (−Z side) as compared with the substrate 172a. The substrate 172 and the substrate 172a are disposed with portions overlapping each other in the axial direction.

(Inverter Housing 171)

The inverter housing 171 has a cylindrical shape with a bottom and has a bottom surface portion 171a, a side wall portion 171b, a substrate support portion 171c, a side wall portion 171d, and a flange portion 171e.

The bottom surface portion 171a spreads in a direction that is parallel to a surface that perpendicularly intersects the center axis J. The bottom surface portion 171a has a boss 171f that projects on the rear side (−Z side) on the surface on the rear side (−Z side). The boss 171f has a screw hole extending on the front side (+Z side) from an end surface on the rear side (−Z side).

The side wall portion 171b extends on the rear side (−Z side) from an end of the bottom surface portion 171a located outward in the radial direction. The substrate support portion 171c extends outward in the radial direction from an end of the side wall portion 171b on the rear side (−Z side). The side wall portion 171d extends on the rear side (−Z side) from an end of the substrate support portion 171c located outward in the radial direction. The flange portion 171e extends outward in the radial direction from an end of the side wall portion 171d on the rear side (−Z side).

The inverter housing 171 is disposed on the front side (+Z side) of the pump body 31. A surface of a flange portion 171e of the inverter housing 171 on the rear side (−Z side) comes into contact with a surface of a flange portion 31c of the pump body 31 on the front side (+Z side). The inverter housing 171 is secured to the pump body 31 by fastening the flange portion 171e and the flange portion 31c with a fastening member 35 such as a bolt and a nut.

A surface of the substrate support portion 171c on the rear side (−Z side) comes into contact with a surface of the substrate 172 on the front side (+Z side). The substrate 172 is secured to the inverter housing 171 by fastening the substrate 172 and the substrate support portion 171c with a fastening member 172e such as a screw.

A surface of the boss 171f on the rear side (−Z side) comes into contact with a surface of the substrate 172a on the front side (+Z side). The substrate 172a is secured to the inverter housing 171 by fastening the substrate 172a and the boss 171f with a fastening member 172m such as a screw.

(Substrate 172)

On the substrate 172, a rotation angle detection sensor 172b and an electronic component 172h that configure a rotation angle detection circuit 190 are mounted. The electronic component 172h includes a heat generating element.

On a surface of the substrate 172 on the rear side (−Z side), the rotation angle detection sensor 172b and the electronic component 172h are mounted. The rotation angle detection sensor 172b and the electronic component 172h are disposed between the substrate 172 and the pump body 31.

The rotation angle detection sensor 172b is disposed at a position at which the rotation angle detection sensor 172b faces a rotation angle sensor magnet 72d. If a motor shaft 41 rotates, then the rotation angle sensor magnet 72d also rotates, and a magnetic flux is thus changed. The rotation angle detection sensor 172b is, for example, an MR sensor, detects the change in magnetic flux due to the rotation of the rotation angle sensor magnet 72d, and thus detects a rotation angle of the motor shaft 41.

A heat discharge member 172i is disposed between a surface of the electronic component 172h on the rear side (−Z side) and an end surface 31d of the pump body 31 on the front side (+Z side). The heat discharge member 172i is a high heat transmission member, and a heat discharge gel is used, for example.

(Substrate 172a)

On the substrate 172a, electronic components 172f and 172g that configure an inverter circuit 180 for driving a motor portion 20 are mounted. The electronic components 172f and 172g include heat generating elements such as a switching element (for example, a field effect transistor (FET) or an insulation gate bipolar transistor (IGBT)) and a capacitor.

The electronic components 172f and 172g are mounted on a surface of the substrate 172a on the rear side (−Z side). The electronic components 172f and 172g are disposed between the substrate 172a and the substrate 172.

The heat discharge member (not illustrated; a heat discharge gel, for example) may be disposed between positions at which the electronic components 172f and 172g are mounted and the bottom surface portion 171a in the surface of the substrate 172a on the front side (+Z side).

The heat generated by the electronic components 172f and 172g is likely to move to the inverter housing 171, and it is possible to improve heat discharge efficiency of the substrate 172a by providing the heat discharge member.

(Inverter Circuit 180)

The inverter circuit 180 is configured by mounting the electronic components 172f and 172g and various electronic components (not illustrated) on the substrate 172a. The inverter circuit 180 includes a heat generating element. The inverter circuit 180 supplies electric power to the motor portion 20 and controls operations, such as driving, rotation, and stop of the motor portion 20. The control can be performed on the basis of the rotation angle of the motor shaft 41 detected by the rotation angle detection circuit 190.

(Rotation Angle Detection Circuit 190)

The rotation angle detection circuit 190 is configured by mounting the rotation angle detection sensor 172b, the electronic component 172h, and various electronic components (not illustrated) on the substrate 172. The rotation angle detection circuit 190 includes a heat generating element. The rotation angle detection circuit 190 detects a rotation angle of the motor shaft 41. The result of detection performed by the rotation angle detection circuit 190 is delivered to the inverter circuit 180 via a connector or the like that electrically connects a print wiring on the substrate 172 to a print wiring on the substrate 172a. According to the embodiment, there is no need to arrange the wiring for connecting the substrate 172 to the substrate 172a by disposing the substrate 172 and the substrate 172a at close positions.

### Third Embodiment

### <Inverter Portion 270>

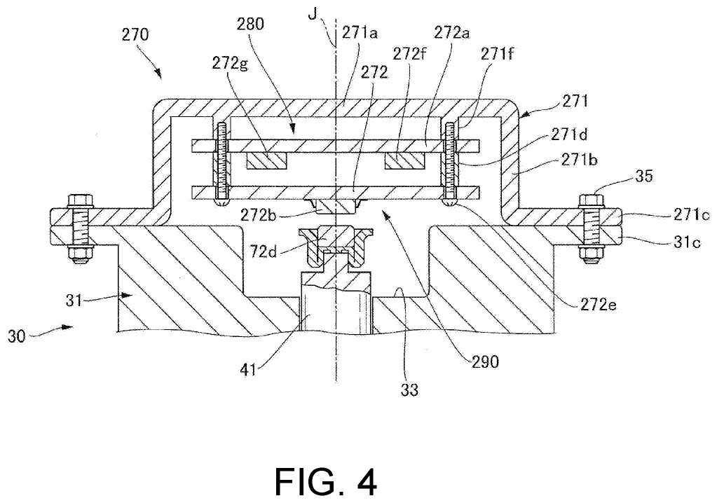

FIG. 4 is an enlarged sectional view illustrating an inverter portion 270 according to a third embodiment. In the third embodiment, the inverter portion 270 is included instead of the inverter portion 70 in the first embodiment. Since configurations of a motor portion 20 and a pump portion 30 in the third embodiment are the same as those in the first embodiment illustrated in FIG. 1, illustration and detailed description thereof will be omitted.

The inverter portion 270 is provided on the front side (+Z side) of the pump portion 30 and controls driving of the motor portion 20. The inverter portion 270 has an inverter housing 271, a substrate 272, and a substrate 272a. The substrate 272 and the substrate 272a are stacked in the axial direction. The substrate 272 is disposed on the rear side (−Z side) as compared with the substrate 272a. The substrate 272 and the substrate 272a are disposed with portions overlapping each other in the axial direction.

(Inverter Housing 271)

The inverter housing 271 has a cylindrical shape with a bottom and has a bottom surface portion 271a, a side wall portion 271b, and a flange portion 271c.

The bottom surface portion 271a spreads in a direction that is parallel to a surface that perpendicularly intersects the center axis J. The bottom surface portion 271a has a boss 271f that projects on the rear side (−Z side) in a surface on the rear side (−Z side). The boss 271f has a crew hole extending on the front side (+Z side) from an end surface on the rear side (−Z side).

The side wall portion 271b extends on the rear side (−Z side) from an end of the bottom surface portion 271a located outward in the radial direction. The flange portion 271c extends outward in the radial direction from an end of the side wall portion 271b on the rear side (−Z side).

The inverter housing 271 is disposed on the front side (+Z side) of the pump body 31. A surface of the flange portion 271c of the inverter housing 271 on the rear side (−Z side) comes into contact with a surface of a flange portion 31c of the pump body 31 on the front side (+Z side). The inverter housing 271 is secured to the pump body 31 by fastening the flange portion 271c and the flange portion 31c with a fastening member 35 such as a bolt and a nut.

A surface of the boss 271f on the rear side (−Z side) comes into contact with a surface of the substrate 272a on the front side (+Z side). A spacer 271d that is a cylindrical member is disposed between the substrate 272a and the substrate 272. A surface of the substrate 272a on the rear side (−Z side) comes into contact with a surface of the spacer 271d on the front side (+Z side). A surface of the spacer 271d on the rear side (−Z side) comes into contact with a surface of the substrate 272 on the front side (+Z side). The substrate 272a and the substrate 272 are secured to the inverter housing 271 by fastening the substrate 272, the spacer 271d, the substrate 272a, and the boss 271f with a fastening member 272e such as a screw.

(Substrate 272) On the substrate 272, a rotation angle detection sensor 272b that configures a rotation angle detection circuit 290 is mounted.

On a surface of the substrate 272 on the rear side (−Z side), the rotation angle detection sensor 272b is mounted. The rotation angle detection sensor 272b is disposed between the substrate 272 and the pump body 31.

The rotation angle detection sensor 272b is disposed at a position at which the rotation angle detection sensor 272b faces a rotation angle sensor magnet 72d. If a motor shaft 41 rotates, then the rotation angle sensor magnet 72d also rotates, and a magnetic flux is thus changed. The rotation angle detection sensor 272b is, for example, an MR sensor, detects a change in magnetic flux due to the rotation of the rotation angle sensor magnet 72d, and thus detects a rotation angle of the motor shaft 41.

(Substrate 272a)

On the substrate 272a, electronic components 272f and 272g that configure an inverter circuit 280 for driving the motor portion 20 are mounted. The electronic components 272f and 272g include heat generating elements such as a switching element (for example, a field effect transistor (FET) and an insulation gate bipolar transistor (IGBT)) and a capacitor.

On a surface of the substrate 272a on the rear side (−Z side), the electronic components 272f and 272g are mounted. The electronic components 272f and 272g are disposed between the substrate 272a and the substrate 272.

A heat discharge member (not illustrated; a heat discharge gel, for example) may be disposed between positions at which the electronic components 272f and 272g are mounted and the bottom surface portion 271a in the surface of the substrate 272a on the front side (+Z side). The heat generated by the electronic components 272f and 272g is likely to move to the inverter housing 271, and it is possible to improve heat discharge efficiency of the substrate 272a by providing the heat discharge member.

(Inverter Circuit 280)

The inverter circuit 280 is configured by mounting the electronic components 272f and 272g and various electronic components (not illustrated) on the substrate 272a. The inverter circuit 280 includes a heat generating element. The inverter circuit 280 supplies electric power to the motor portion 20 and controls operations such as driving, rotation, and stop of the motor portion 20. The control can be performed on the basis of the rotation angle of the motor shaft 41 detected by the rotation angle detection circuit 290.

(Rotation Angle Detection Circuit 290)

The rotation angle detection circuit 290 is configured by mounting the rotation angle detection sensor 272b and various electronic components (not illustrated) on the substrate 172. The rotation angle detection circuit 290 detects a rotation angle of the motor shaft 41. The result of detection performed by the rotation angle detection circuit 290 can be delivered to the inverter circuit 280 via a connector or the like that electrically connects a print wiring on the substrate 272 to a print wiring on the substrate 272a. According to the embodiment, there is no need to arrange a wiring for connecting the substrate 272 to the substrate 272a by disposing the substrate 272 and the substrate 272a at close positions.

<Effects and Advantages of Electric Oil Pump>

Next, effects and advantages of the electric oil pump will be described.

(1) In the disclosure according to the aforementioned embodiments, an electric oil pump includes: a motor portion that has a motor shaft extending in an axial direction and disposed along a center axis; a pump portion that is disposed on one side of the motor portion in the axial direction, is driven by the motor portion via the motor shaft, and suctions and ejects an oil, and an inverter portion that is disposed on one side of the pump portion in the axial direction and drives the motor portion, the motor shaft penetrates through the pump portion, and the electric oil pump further includes a rotation angle sensor that is disposed at the inverter portion and detects a rotation angle of the motor shaft.

Therefore, it is possible to provide an electric oil pump that does not degrade assembly operability and does not require a complicated configuration in a configuration in which a pump portion is disposed on one side of a motor portion in an axial direction and an inverter portion is disposed on one side of the pump portion in the axial direction.

By the rotation angle sensor being disposed at the inverter portion, it is possible to eliminate a wiring between the rotation angle sensor and the inverter portion.

By the motor shaft penetrating through the pump portion, it is possible to detect a rotation angle of the motor shaft with the rotation angle sensor disposed at the inverter portion.

In a configuration in which the motor portion, the pump portion, and the inverter portion are disposed in this order from the other side in the axial direction to one side in the axial direction, the motor shaft penetrates through the pump portion, a rotation angle sensor magnet is disposed at an end of the motor shaft on one side in the axial direction, and the rotation angle sensor is disposed at the inverter portion such that the rotation angle sensor faces the rotation angle sensor magnet. With this configuration, it is possible to realize a size reduction in the axial direction as compared with a case in which the rotation angle sensor is disposed on the other side in the axial direction, there is no need to use a wiring or the like from the rotation angle sensor to the inverter portion, and it is thus possible to improve assembly operability.

(2) In addition, the electric oil pump further includes a rotation angle sensor magnet that is disposed at an end on one side of the motor shaft in the axial direction and rotates along with the motor shaft, and the rotation angle sensor is disposed to face the rotation angle sensor magnet and detects a rotation angle of the rotation angle sensor magnet.

The rotation angle sensor magnet is disposed on one side of the motor shaft, through which the pump portion penetrates, in the axial direction, and the rotation angle detection sensor can detect a rotation angle of the motor shaft by detecting a rotation angle of the rotation angle sensor magnet.

(3) In addition, the inverter portion has a substrate on which the rotation angle sensor is mounted and an inverter housing, and the substrate is secured to the inverter housing.

Since the substrate of the inverter portion is secured to the inverter housing, it is possible to improve assembly operability.

(4) In addition, the inverter portion includes a control driving substrate on which a drive circuit for driving the motor portion is mounted, a rotation angle sensor substrate on which the rotation angle sensor is mounted, and an inverter housing, and the control driving substrate and the rotation angle sensor substrate are secured to the inverter housing.

Since the control driving substrate and the rotation angle sensor substrate of the inverter portion are secured to the inverter housing, it is possible to improve assembly operability.

(5) In addition, the control driving substrate and the rotation angle sensor substrate are stacked in the axial direction.

Since the control driving substrate and the rotation angle sensor substrate are stacked in the axial direction, it is possible to prevent the size from increasing in the radial direction.

(6) In addition, the pump portion has a pump body, and the electric oil pump further includes a heat discharge gel disposed between the substrate and the pump body.

Heat generated by the heat generating element such as a switching element (for example, an FET or an IGBT) mounted on the substrate is likely to move to the pump body via a heat discharge gel, and heat discharge efficiency of the substrate is improved.

(7) The rotation angle sensor is an MR sensor.

By the rotation angle sensor being an MR sensor, it is possible to reduce the size of the configuration for detecting the rotation angle. Also, control of the electric oil pump is facilitated in a situation of a vehicle.

(8) The pump portion includes a bearing portion that is a bearing of the motor shaft.

By the pump portion having the bearing, it is possible to axially support the motor shaft on the side of one end in the axial direction and to easily curb eccentricity of the motor shaft.

(9) The bearing portion is a sliding bearing.

By the bearing portion being a sliding bearing, it is possible to enhance durability of the bearing portion.

Applications of the electric oil pump according to the aforementioned embodiments are not particularly limited. The electric oil pump according to the aforementioned embodiments is mounted on a vehicle, for example. Also, the aforementioned respective configurations can appropriately be combined as long as no confliction occurs therein.

Although preferred embodiments of the disclosure have been described above, the disclosure is not limited to these embodiments, and various modifications and changes can be made within the gist thereof. These embodiments and modifications thereof are included in the scope and the gist of the disclosure, and also, in the inventions described in claims and a range equivalent thereto.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electric oil pump comprising:
a motor portion that has a motor shaft disposed along a center axis extending in an axial direction;
a pump portion that is disposed on one side of the motor portion in the axial direction, is driven by the motor portion via the motor shaft, and suctions and ejects an oil, and
an inverter portion that is disposed on one side of the pump portion in the axial direction and drives the motor portion,
wherein the motor shaft penetrates through the pump portion, and
the electric oil pump further includes a rotation angle sensor that is disposed at the inverter portion and detects a rotation angle of the motor shaft.

2. The electric oil pump according to claim 1, further comprising:
a rotation angle sensor magnet that is disposed at an end on one side of the motor shaft in the axial direction and rotates along with the motor shaft,
wherein the rotation angle sensor is disposed to face the rotation angle sensor magnet and detects a rotation angle of the rotation angle sensor magnet.

3. The electric oil pump according to claim 1,
wherein the inverter portion has a substrate on which the rotation angle sensor is mounted and an inverter housing, and
the substrate is secured to the inverter housing.

4. The electric oil pump according to claim 1,
wherein the inverter portion includes a control driving substrate on which a drive circuit for driving the motor portion is mounted, a rotation angle sensor substrate on which the rotation angle sensor is mounted, and an inverter housing, and
the control driving substrate and the rotation angle sensor substrate are secured to the inverter housing.

5. The electric oil pump according to claim 4, wherein the control driving substrate and the rotation angle sensor substrate are stacked in the axial direction.

6. The electric oil pump according to claim 3,
wherein the pump portion has a pump body, and
the electric oil pump further includes a heat discharge gel disposed between the substrate and the pump body.

7. The electric oil pump according to claim 2,
wherein the rotation angle sensor is an MR sensor.

8. The electric oil pump according to claim 1, wherein the pump portion includes a bearing portion that is a bearing of the motor shaft.

9. The electric oil pump according to claim 8, wherein the bearing portion is a sliding bearing.
